(19) United States
(12) Patent Application Publication
(10) Pub. No.: US 2001/0048750 A1
(43) Pub. Date: Dec. 6, 2001

(54) Electret condenser microphone and method of assembling the same

(75) Inventors: Motoaki Ito, Shizuoka-shi (JP); Mikio Suzuki, Shizuoka-shi (JP); Tomonari Suzuki, Shizuoka-shi (JP); Yasunori Tsukuda, Shizuoka-shi (JP)

Correspondence Address: MORGAN, LEWIS & BOCKIUS, 1800 M STREET NW, WASHINGTON, DC, 20036-5869, US

(73) Assignee: STAR MICRONICS CO. LTD.

(21) Appl. No.: 09/866,809

(22) Filed: May 30, 2001

(30) Foreign Application Priority Data
May 30, 2000 (JP) P2000-160724

(51) Int. Cl. H04R 9/08

(52) U.S. Cl. 381/355; 381/361

(57) ABSTRACT

An insulating bushing of an electret condenser microphone is disposed on the rear side of a back electrode portion and abuts against the rear surface of back electrode plate. When a predetermined force is applied to the insulating bushing from the opened end of the case by way of a fixing ring and a printed circuit board, the insulating bushing deforms so as to fit into a gap formed between the inner peripheral face of the case and an end portion of the back electrode plate. Since the insulating bushing fits between the inner peripheral face of the case and the end portion of the back electrode plate, the back electrode plate is positioned and fixed with respect to the case in a state where the back electrode plate and the case are electrically insulated from each other.

### BACKGROUND OF THE INVENTION

1. Field of the Invention

The present invention relates to an electret condenser microphone and a method of assembling the same.

2. Related Background Art

Known as this kind of electret condenser microphone is one disclosed in Japanese Utility Model No. 3011048, for example. The electret condenser microphone disclosed in Japanese Utility Model No. 3011048 comprises a cylindrical metal case having one end face closed with its front faceplate and the other end opened. The center of the front faceplate is formed with a sound hole. Contained within the metal case is a diaphragm attached to a diaphragm ring, whereas the front face of the diaphragm ring is in contact with the front faceplate of the metal case. By way of a spacer, a back electrode plate as a fixed electrode is disposed so as to oppose the diaphragm on the rear side thereof with a predetermined gap therebetween. A cylindrical support is disposed on the rear side of the back electrode plate, whereas the back electrode plate is positioned as being engaged with a stage formed in this support and is supported thereby so as to face the diaphragm. The diaphragm and the back electrode plate form a condenser portion.

Disposed on the rear side of the back electrode plate is a printed-circuit board mounted with an impedance converter for converting a change in electrostatic capacity of the condenser portion into an electric impedance. In the final step of assembling thus configured electret condenser microphone, the edge of metal case on the opened end is caulked so as to be curled inward and come into electric contact with a grounding pattern formed on the printed-circuit board.

In the electret condenser microphone such as the one disclosed in Japanese Utility Model No. 3011048, however, it is necessary to enhance the accuracy in forming the stage on the support in order to securely insulate the back electrode plate from the case, whereby the processing of the support becomes complicated. Hence, there has been a limit to improving the productivity of electret condenser microphones.

Also, the electret condenser microphone such as the one disclosed in Japanese Utility Model No. 3011048 is configured such that components such as the diaphragm ring, back electrode plate, support, and printed-circuit board are assembled into the metal case upon caulking the edge of metal case on the opened end thereof, whereby the airtightness in the space formed within the metal case may lower when the caulking of the opened end edge is insufficient.

### SUMMARY OF THE INVENTION

In view of the foregoing, it is an object of the present invention to provide an electret condenser microphone which can improve the productivity, and a method of assembling the same.

For achieving the above-mentioned object, the present invention provides an electret condenser microphone comprising a tubular case having one end provided with a bottom portion to be used as a front faceplate and the other end opened, a diaphragm and a back electrode plate being successively inserted into the case from the opened end, the diaphragm and the back electrode being disposed with a predetermined gap therebetween within the case; the electret condenser microphone further comprising an insulating bushing press-fitted into the case from the opened end so as to abut against a surface of the back electrode plate facing the opened end of the case, wherein when a predetermined force is applied to the insulating bushing from the opened end of the case, the insulating bushing is deformed so as to fit between an inner peripheral face of the case and an end portion of the back electrode plate.

The electret condenser microphone of the present invention has an insulating bushing press-fitted into the case from the opened end of the case so as to abut against the rear surface of the back electrode plate, and a predetermined force is applied to the insulating bushing from the opened end of the case, whereby the insulating bushing is deformed so as to fit between the inner peripheral face of the case and an end portion of the back electrode plate. As a consequence, the back electrode plate is fixed with respect to the case and is securely insulated from the case. Therefore, the processing accuracy required for the insulating bushing lowers, so that the insulating bushing can be processed easily. As a result, the productivity of electret condenser microphone can be improved.

The electret condenser microphone of the present invention may further comprise a printed circuit board mounted with an impedance converter for converting a change in electrostatic capacity between the diaphragm and the back electrode plate into an electric impedance, and a fixing ring disposed to the opened end of the case than the printed circuit board, the printed circuit board and the fixing ring being inserted into the case from the opened end in a state where the insulating bushing is press-fitted into the case, the fixing ring and the case being welded and fixed to each other in a state where the predetermined force is applied to the fixing ring.

In this case, components such as the printed circuit board can be assembled into the case without caulking the opened end portion of the case, whereby the electret condenser microphone can be assembled easily. Also, since the fixing ring and the case are welded and fixed to each other in a state where the predetermined force is applied to the fixing ring, airtightness can be restrained from lowering in the space defined by the printed circuit board and the diaphragm.

Also, in the electret condenser microphone of the present invention, the diaphragm and the back electrode plate may be disposed with the predetermined gap therebetween by way of a spacer, and the predetermined force applied to the insulating bushing from the opened end of the case may be set to a value at which the insulating bushing deforms such that a part fitted between the inner peripheral face of the case and the end portion of the back electrode plate abuts against the spacer.

In this case, the predetermined force applied to the insulating bushing from the opened end of the case can be controlled easily.

For achieving the above-mentioned object, the present invention provides a method of assembling an electret condenser microphone in which, into a tubular case having one end provided with a bottom portion to be used as a front faceplate and the other end opened, a diaphragm and a back electrode plate are successively inserted from the opened end; the method comprising the steps of press-fitting an insulating bushing into the case from the opened end; and applying a predetermined force to the insulating bushing from the opened end of the case so as to deform the insulating bushing such that the insulating bushing fits between an inner peripheral face of the case and an end portion of the back electrode plate, thereby fixing the back electrode plate to the case.

In the state where the diaphragm and the back electrode plate are inserted, the insulating bushing is press-fitted into the case from the opened end of the case, and the predetermined force is applied to the insulating bushing from the opened end of the case, so as to deform the insulating bushing such that it fits between the inner peripheral face of the case and the end portion of the back electrode plate, thereby fixing the back electrode plate to the case. Consequently, the processing accuracy required for the insulating bushing lowers, whereby the insulating bushing can be processed easily. As a result, the productivity of electret condenser microphone can be improved.

The method of assembling an electret condenser microphone in accordance with the present invention may comprise the steps of successively inserting a printed circuit board mounted with an impedance converter for converting a change in electrostatic capacity between the diaphragm and the back electrode into an electric impedance, and a fixing ring into the case from the opened end in a state where the insulating bushing is press-fitted into the case; and welding and fixing the fixing ring and the case to each other in a state where the predetermined force is applied to the fixing ring.

In this case, components such as the printed circuit board can be assembled into the case without caulking the opened end portion of the case, whereby the electret condenser microphone can be assembled easily. Also, since the fixing ring and the case are welded and fixed to each other in a state where the predetermined force is applied to the fixing ring, airtightness can be restrained from lowering in the space defined by the printed circuit board and the diaphragm.

The method of assembling an electret condenser microphone in accordance with the present invention may further comprise the steps of disposing a spacer between the diaphragm and the back electrode plate; and setting the predetermined force applied to the insulating bushing from the opened end of the case to a value at which the insulating bushing deforms such that a part fitted between the inner peripheral face of the case and the end portion of the back electrode plate abuts against the spacer.

In this case, the predetermined force applied to the insulating bushing from the opened end of the case can be controlled easily.

The present invention will become more fully understood from the detailed description given hereinbelow and the accompanying drawings. They are given by way of illustration only, and thus should not be considered limitative of the present invention.

Further scope of applicability of the present invention will become apparent from the detailed description given hereinafter. However, it is clear that the detailed description and specific examples, while indicating preferred embodiments of the invention, are given by way of illustration only, and various changes and modifications within the spirit and scope of the invention will become apparent to those skilled in the art from this detailed description.

### BRIEF DESCRIPTION OF THE DRAWINGS

FIG. 1 is a perspective view showing the exterior of an electret condenser microphone as a whole;

FIG. 2 is a perspective view showing the exterior of the electret condenser microphone as a whole;

FIG. 3 is a sectional view of the electret condenser microphone;

FIG. 4 is an exploded perspective view showing the configuration of the electret condenser microphone;

FIG. 5 is an exploded perspective view showing the configuration of the electret condenser microphone;

FIG. 6 is an exploded perspective view showing the configuration of a diaphragm subassembly contained in the electret condenser microphone;

FIG. 7 is an exploded perspective view showing the configuration of a back electrode portion contained in the electret condenser microphone;

FIG. 8A is a sectional view of a major part of the electret condenser microphone, showing a state before a force is applied to a fixing ring;

FIG. 8B is a sectional view of the major part of the electret condenser microphone, showing a state where the force is applied to the fixing ring;

FIG. 8C is a sectional view of the major part of the electret condenser microphone, showing a state where the force is applied to the fixing ring; and

FIG. 9 is a graph showing a relationship between the force applied to the fixing ring and the amount of collapse of an insulating bushing.

### DESCRIPTION OF THE PREFERRED EMBODIMENT

In the following, a preferred embodiment of the electret condenser microphone in accordance with the present invention will be explained in detail with reference to the drawings. Among the drawings, constituents identical to each other or having functions identical to each other will be referred to with numerals identical to each other without repeating their overlapping explanations.

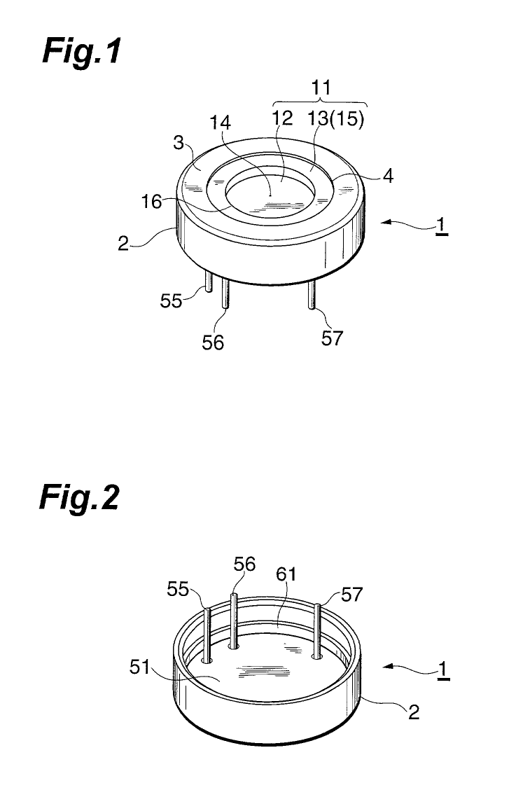

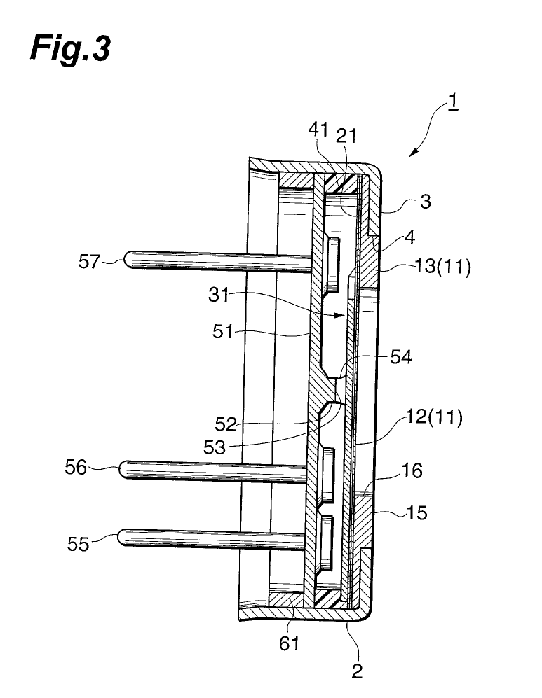

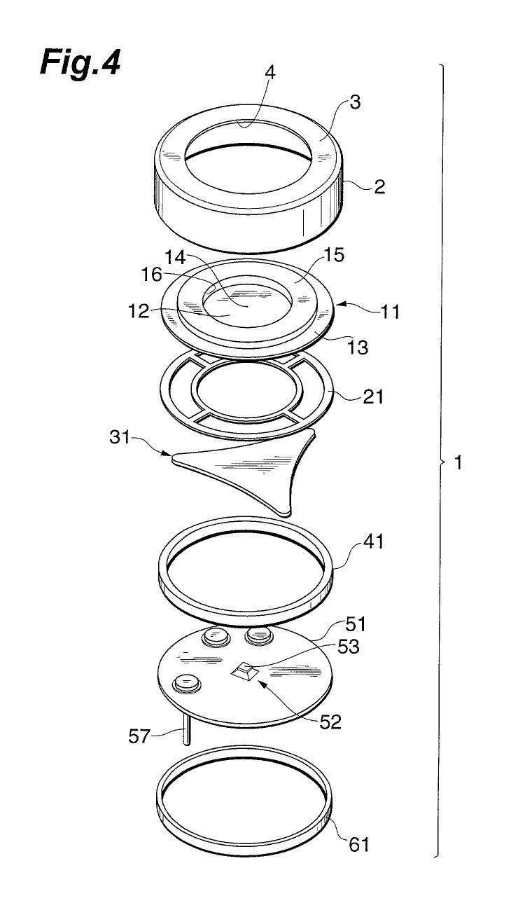

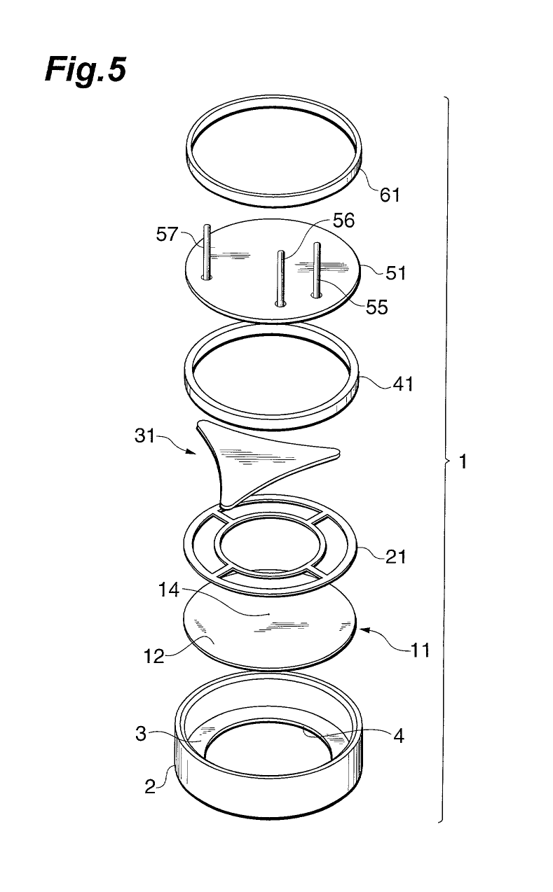

As shown in FIGS. 1 and 2, an electret condenser microphone 1 comprises a case 2. This case 2 is constituted by a member made of a metal (e.g., stainless steel) having one end provided with a bottom portion 3 to be used as a front faceplate and the other end opened. The case 2 has been pressed into a cylindrical form having the bottom portion 3 (front faceplate). The bottom portion 3 of the case 2 is formed with an aperture 4 having a predetermined form (e.g., circular form). As shown in FIGS. 3 to 5, the case 2 contains therein a diaphragm subassembly 11, a spacer 21, a back electrode portion 31, an insulating bushing 41, a printed circuit board 51, and a fixing ring 61.

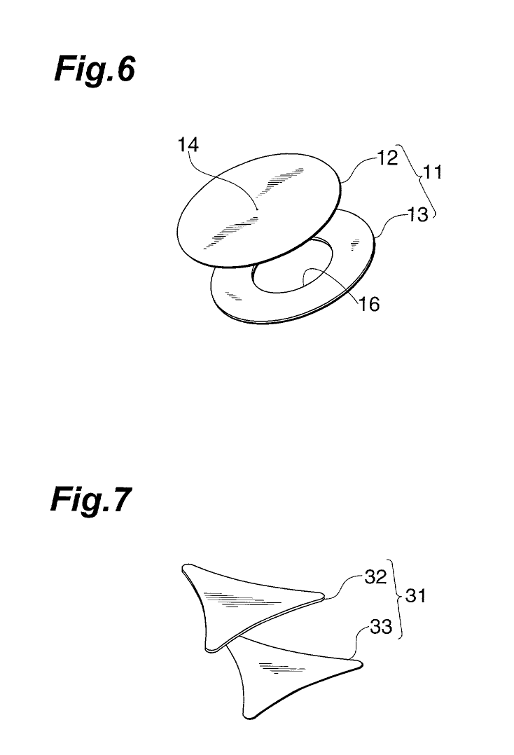

As shown in FIG. 6, the diaphragm subassembly 11 has a diaphragm 12 and a diaphragm frame 13. The diaphragm 12 is made of a PET (Polyethylene Terephthalate) film having a thickness of about 1.5 μm and is attached to the diaphragm frame 13. On the surface of diaphragm 12 bonded to the diaphragm frame 13, Au is vapor-deposited. Formed at the center part of the diaphragm 12 is a vent hole (through hole) 14 for regulating the atmospheric pressure between the inside and outside of the electret condenser microphone 1. The diameter of the vent hole 14 is set to about 65 μm, for example.

The diaphragm frame 13 is constituted by a member made of a metal (e.g., phosphor bronze) having a substantially disk-like form, whereas the outside diameter of the diaphragm frame 13 is set smaller than the inside diameter of the case 2. The outside diameter of the diaphragm frame 13 is set to about 8.2 mm, for example. The inside diameter of the case 2 is set to about 8.5 mm, for example.

The surface (rear side) of diaphragm frame 13 opposite to the surface attached to the diaphragm 12 is integrally formed with a ring-shaped positioning projection 15. The positioning projection 15 is disposed at a position corresponding to the aperture 4 of the bottom portion 3, and fits into the aperture 4 of the bottom portion 3 when the diaphragm frame 13 is placed within the case 2. Thus, when the positioning protrusion 15 fits into the aperture 4 of the bottom portion 3, the diaphragm subassembly 11 (diaphragm frame 13) is positioned with respect to the case 2. The inner peripheral portion of the positioning projection 15 of the diaphragm frame 13 is formed with a sound hole 16.

In the state where the diaphragm subassembly 11 (diaphragm frame 13) is disposed within the case 2 such that the positioning projection 15 fits in the aperture 4, a predetermined gap is formed between the outer peripheral face of the diaphragm frame 13 and the inner peripheral face of the case 2 as shown in FIG. 3. Also, in the state where the positioning projection 15 fits in the aperture 4 of the bottom portion 3, the surface of diaphragm frame 13 opposite to the surface attached to the diaphragm 12 abuts against the bottom portion 3, whereby the diaphragm frame 13 and the case 2 are electrically connected to each other.

The diaphragm 12 is attached to the diaphragm frame 13 as follows. First, in a state where a predetermined tension is applied to a sheet-like PET film which will constitute the diaphragm 12, a plurality of diaphragm frames 13 are bonded to the sheet-like PET film. Then, in the state where the diaphragm frame 13 and the diaphragms 12 are bonded together, the sheet is cut along the outer form of diaphragm frame 13.

The back electrode portion 31 is disposed on the rear side of the diaphragm subassembly 11, i.e., to the opened end (the other end) of the case 2 than the diaphragm subassembly 11. As shown in FIG. 7, the back electrode portion 31 has a back electrode plate 32 and an electret 33. The electret 33 is constituted by an FEP (Fluorinated Ethylene Propylene) film. The back electrode plate 32 is constituted by a member made of a metal (e.g., stainless steel) having a substantially triangular form, whose one surface is thermally fused (laminated) with the electret 33. The back electrode portion 31 is disposed such that the surface of back electrode plate 32 thermally fused with the electret 33 faces the diaphragm 12 of the diaphragm subassembly 11. The size of the back electrode plate 32 is set such that a predetermined gap (e.g., about 0.1 mm) is formed between the inner peripheral face of the case 2 and end portions of the back electrode plate 32 in the state where the back electrode plate 32 is disposed within the case 2 such that the center position of the back electrode portion 31 (back electrode plate 32) and the center position of the case 2 align with each other.

The back electrode portion 31 is formed when a metal material, which will constitute the back electrode plate 32, thermally fused with the electret 33 is punched into a substantially triangular form. After the back electrode portion 31 is formed by punching, the electret 33 is corona-charged so as to yield a predetermined surface charge (e.g., about −360 V).

Disposed between the back electrode portion 31 and the diaphragm subassembly 11 is a spacer 21, which is made of stainless steel or the like and has a thickness set to about 40 μm. As a consequence, the diaphragm 12 and the back electrode plate 32 (electret 33) are disposed with a predetermined gap (about 40 μm) therebetween by way of the spacer 21. The diaphragm 12 and the back electrode plate 32 form a condenser portion.

The insulating bushing 41 is made of a resin, an elastomer, or the like, and is press-fitted into the case 2. The insulating bushing 41 is made of PTFE (Polytetrafluoroethylene), for example. The insulating bushing 41 is disposed on the rear side of the back electrode portion 31, i.e., to the opened end of the case 2 than the back electrode portion 31, and abuts against the rear surface of back electrode plate 32.

As will be explained later, the insulating bushing 41 deforms when a predetermined force is applied thereto from the opened end of the case 2, thereby fitting into the gap formed between the inner peripheral face of the case 2 and the end portions of the back electrode plate 32. Since the insulating bushing 41 fits between the inner peripheral face of the case 2 and the end portions of the back electrode plate 32, the back electrode plate 32 (back electrode portion 31) is positioned with respect to the case 2 in a state where the back electrode plate 32 and the case 2 are electrically insulated from each other.

The printed circuit board 51 is mounted with a JEFT (Junction Field-Effect Transistor) chip 52 as an impedance converter for converting a change in electrostatic capacity (of the condenser portion) between the diaphragm 12 and the back electrode plate 32 into an electric impedance. The upper face of the JEFT chip 52 is formed with a gate electrode 53. The gate electrode 53 is bonded and fixed to the back electrode plate 32 by an electrically conductive adhesive 54, so as to be electrically connected to the back electrode plate 32 by way of the electrically conductive adhesive 54.

From the rear face of printed circuit board 51 (opposite to the surface provided with the JEFT chip 52), a power terminal pin 55, an output terminal pin 56, and a ground terminal pin 57 project vertically. The ground terminal pin 57 is electrically connected to the diaphragm 12 by way of the case 2. The power terminal pin 55 and the output terminal pin 56 are electrically connected to the drain electrode (not depicted) and source electrode (not depicted) of the JEFT chip 52, respectively.

The fixing ring 61 is disposed on the rear side of the printed circuit board 51, i.e., to the opened end of the case 2 than the printed circuit board 51, and abuts against the rear face of the printed circuit board 51 (opposite to the surface provided with the JEFT chip 52). The fixing ring 61 is made of stainless steel or the like. The fixing ring 61 and the case 2 are fixed to each other by laser welding or the like in a state where the predetermined force is applied to the fixing ring 61 from the opened end of the case 2.

A method of assembling the electret condenser microphone 1 will now be explained.

First, the diaphragm subassembly 11 and the spacer 21 are successively inserted into the case 2. When the positioning projection 15 of the diaphragm frame 13 fits into the aperture 4 of the case 2, the diaphragm subassembly 11 is positioned with respect to the case 2.

After the diaphragm subassembly 11 and the spacer 21 are completely inserted into the case 2, the back electrode portion 31 and the insulating bushing 41 are inserted therein by an automatic assembly machine. The center position of the case 2 is detected by means of an image recognition technique or the like, and the back electrode portion 31 is inserted into the case 2 such that the center position of back electrode portion 31 (back electrode plate 32) separately detected by an image recognition technique or the like aligns with the detected center position of the case 2. After the back electrode portion 31 is inserted, the insulating bushing 41 is press-fitted (inserted) to a position in contact with the back electrode plate 32. When the insulating bushing 41 is thus press-fitted so as to be inserted to the position in contact with the back electrode plate 32, the diaphragm subassembly 11, spacer 21, and back electrode portion 31 can be kept in a state where they are held between the bottom portion 3 of the case 2 and the insulating bushing 41. When the insulating bushing 41 is press-fitted so as to hold the diaphragm subassembly 11, spacer 21, and back electrode portion 31, the back electrode portion 31 (back electrode plate 32) can be restrained from shifting its position due to vibrations occurring upon transfer to a subsequent assembling step, and the like.

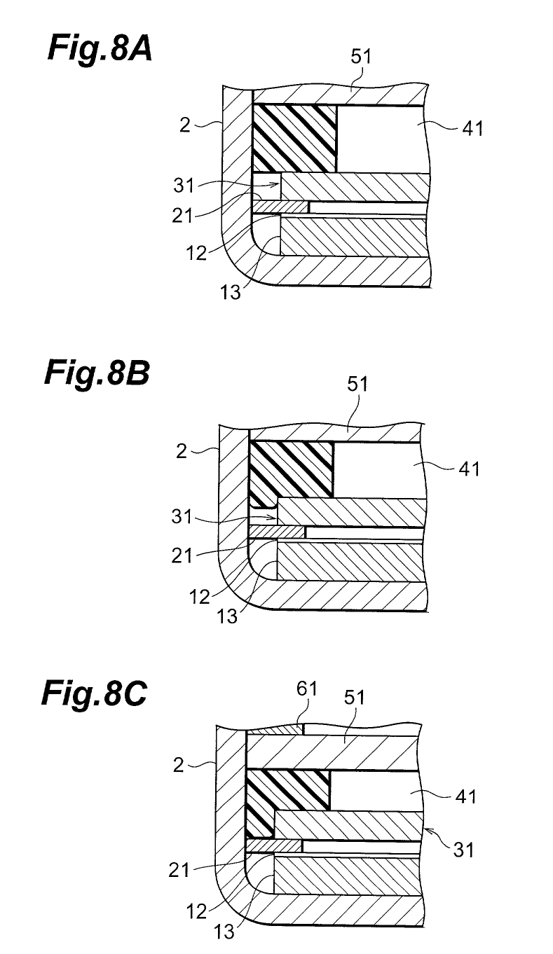

The printed circuit board 51 is mounted with the JEFT chip 52. After an appropriate amount of the electrically conductive adhesive 54 is applied to the gate electrode 53 on the upper face of the JEFT chip 52, the printed circuit board 51 is inserted into the case 2 (in the state shown in FIG. 8A). After the printed circuit board 51 is inserted into the case 2, the fixing ring 61 is inserted into the case 2, and a predetermined force (of about 49.0N, for example) is applied to the upper face of the fixing ring 61 from the opened end of the case 2. The force applied to the fixing ring 61 is transmitted to the insulating bushing 41 by way of the printed circuit board 51, whereby the insulating bushing 41 collapses and deforms, so as to fit between the inner peripheral face of the case 2 and the end portions of the back electrode plate 32 (in the state shown in FIG. 8B). Finally, as shown in FIG. 8C, the insulating bushing 41 abuts against the spacer 21. Thus, the insulating bushing 41 fits between the inner peripheral face of the case 2 and the end portions of the back electrode plate 32, whereby the back electrode plate 32 (back electrode portion 31) is positioned and fixed with respect to the case 2 in the state where the back electrode plate 32 and the case 2 are electrically insulated from each other.

Then, while a predetermined force is applied to the upper face of the fixing ring 61 from the opened end of the case 2, a position located near the center of thickness of the fixing ring 61 is irradiated with laser light by a laser welding machine from the outer periphery side of the case 2, so that the case 2 and the fixing ring 61 are welded and fixed to each other. The case 2 and the fixing ring 61 are welded at four locations set at intervals of about 90°.

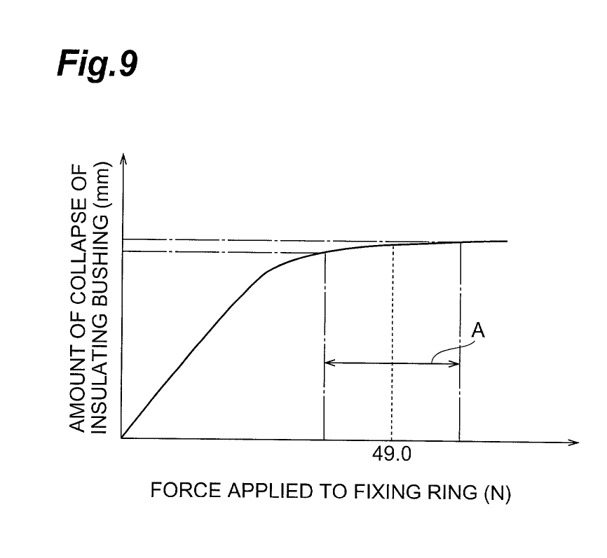

The force applied to the fixing ring 61 is set as follows. Once the insulating bushing 41 collapses and protrudes by the thickness of the back electrode plate 32 so that a part of the insulating bushing 41 abuts against the spacer 21, the amount of collapse of the insulating bushing 41 will change hardly and reach a saturated state even when the force applied to the fixing ring 61 is enhanced as shown in FIG. 9. Therefore, the force applied to the fixing ring is set to such a value that the amount of collapse of the insulating bushing 41 attains a saturated state. In this embodiment, the force applied to the fixing ring 61 is set to about 49.0 N as a value substantially in the middle of a region A where the amount of collapse of the insulating bushing 41 is in a saturated state.

When the insulating bushing 41 is press-fitted into the case 2 to a position in contact with the back electrode plate 32, and a force is applied to the fixing ring 61 from the opened end of the case 2, seal portions are formed between the case 2 and the insulating bushing 41, and between the printed circuit board 51 and the insulating bushing 41. When the seal portions are formed as such, airtightness can be enhanced in the space defined by the printed circuit board 51 and the diaphragm subassembly 11 (diaphragm 12).

As mentioned above, the electret condenser microphone 1 has the insulating bushing 41 press-fitted into the case 2 from the opened end of the case 2 so as to abut against the rear surface of back electrode plate 32, and a predetermined force is applied to the insulating bushing 41 from the opened end of the case 2, whereby the insulating bushing 41 deforms so as to fit between the inner peripheral face of the case 2 and the end portions of the back electrode plate 32. Consequently, the back electrode plate 32 (back electrode portion 31) is fixed with respect to the case 2 and is securely insulated from the latter. Therefore, the processing accuracy required for the insulating bushing 41 lowers, whereby the insulating bushing 41 can be processed easily. As a result, the productivity of electret condenser microphone 1 can be improved.

The electret condenser microphone 1 further comprises the printed circuit board 51 mounted with the JEFT chip 52, and the fixing ring 61 disposed to the opened end of the case 2 than the printed circuit board 51. Also, in the electret condenser microphone 1, the printed circuit board 51 and the fixing ring 61 are inserted into the case 2 from the opened end of the case 2 in the state where the insulating bushing 41 is press-fitted into the case 2, and the fixing ring 61 and the case 2 are welded and fixed to each other in the state where a predetermined force is applied to the fixing ring 61. As a consequence, components such as the printed circuit board 51 can be assembled into the case 2 without caulking the opened end of the case 2, whereby the electret condenser microphone 1 can easily be assembled into the case 2. Also, since the fixing ring 61 and the case 2 are welded and fixed to each other in the state where the predetermined force is applied to the fixing ring 61, airtightness can be restrained from lowering in the space defined by the printed circuit board 51 and the diaphragm subassembly 11 (diaphragm 12).

In the electret condenser microphone 1, the diaphragm subassembly (diaphragm 12) and the back electrode portion 31 (back electrode plate 32) are disposed with a predetermined gap therebetween by way of the spacer 21, and the predetermined force applied to the insulating bushing 41 from the opened end of the case 2 is set to a value at which the insulating bushing 41 deforms such that the part fitted between the inner peripheral face of the case 2 and the end portions of the back electrode plate 32 abuts against the spacer 21. Consequently, the predetermined force applied to the insulating bushing 41 from the opened end of the case 2 can be controlled easily.

Since the force applied to the fixing ring 61 in the electret condenser microphone 1 is set to a value at which the amount of collapse of the insulating bushing 41 attains a saturated state with respect to the force applied to the fixing ring 61, the insulating bushing 41 can securely be deformed until it abuts against the spacer 21. As a result, the thickness (amount of collapse) of insulating bushing 41 can be restrained from fluctuating from product to product.

The insulating bushing 41 in this embodiment is not provided with a stage with which the back electrode plate 32 engages. However, the present invention is also applicable to an electret condenser microphone comprising an insulating bushing formed with a stage. The productivity of electret condenser microphone 1 can be improved in this case as well. The above-mentioned effects of the present invention can also be obtained in the electret condenser microphone comprising an insulating bushing formed with a stage, since the processing accuracy required for forming the stage can be kept low so that the stage can be formed with a processing accuracy lower than that of conventional ones.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An electret condenser microphone comprising a tubular case having one end provided with a bottom portion to be used as a front faceplate and the other end opened;
a diaphragm and a back electrode plate being successively inserted into said case from said opened end, said diaphragm and said back electrode being disposed with a predetermined gap therebetween within said case;
said electret condenser microphone further comprising an insulating bushing press-fitted into said case from said opened end so as to abut against a surface of said back electrode plate facing said opened end of said case;
wherein when a predetermined force is applied to said insulating bushing from said opened end of said case, said insulating bushing is deformed so as to fit between an inner peripheral face of said case and an end portion of said back electrode plate.

2. An electret condenser microphone according to claim 1, wherein said diaphragm and said back electrode plate are disposed with said predetermined gap therebetween by way of a spacer; and
wherein said predetermined force applied to said insulating bushing from said opened end of said case is set to a value at which said insulating bushing deforms such that a part fitted between said inner peripheral face of said case and said end portion of said back electrode plate abuts against said spacer.

3. An electret condenser microphone according to claim 1, further comprising a printed circuit board mounted with an impedance converter for converting a change in electrostatic capacity between said diaphragm and said back electrode plate into an electric impedance, and a fixing ring disposed to said opened end of said case than said printed circuit board;
wherein said printed circuit board and said fixing ring are inserted into said case from said opened end in a state where said insulating bushing is press-fitted into said case; and
wherein said fixing ring and said case are welded and fixed to each other in a state where said predetermined force is applied to said fixing ring.

4. An electret condenser microphone according to claim 3, wherein said diaphragm and said back electrode plate are disposed with said predetermined gap therebetween by way of a spacer; and
wherein said predetermined force applied to said insulating bushing from said opened end of said case is set to a value at which said insulating bushing deforms such that a part fitted between said inner peripheral face of said case and said end portion of said back electrode plate abuts against said spacer.

5. A method of assembling an electret condenser microphone in which, into a tubular case having one end provided with a bottom portion to be used as a front faceplate and the other end opened, a diaphragm and a back electrode plate are successively inserted from said opened end; said method comprising the steps of:
press-fitting an insulating bushing into said case from said opened end; and
applying a predetermined force to said insulating bushing from said opened end of said case so as to deform said insulating bushing such that said insulating bushing fits between an inner peripheral face of said case and an end portion of said back electrode plate, thereby fixing said back electrode plate to said case.

6. A method of assembling an electret condenser microphone according to claim 5, further comprising the steps of:
disposing a spacer between said diaphragm and said back electrode plate; and
setting said predetermined force applied to said insulating bushing from said opened end of said case to a value at which said insulating bushing deforms such that a part fitted between said inner peripheral face of said case and said end portion of said back electrode plate abuts against said spacer.

7. A method of assembling an electret condenser microphone according to claim 5, further comprising the steps of:
successively inserting a printed circuit board mounted with an impedance converter for converting a change in electrostatic capacity between said diaphragm and said back electrode into an electric impedance, and a fixing ring into said case from said opened end in a state where said insulating bushing is press-fitted into said case; and
welding and fixing said fixing ring and said case to each other in a state where said predetermined force is applied to said fixing ring.

8. A method of assembling an electret condenser microphone according to claim 7, further comprising the steps of:
disposing a spacer between said diaphragm and said back electrode plate; and
setting said predetermined force applied to said insulating bushing from said opened end of said case to a value at which said insulating bushing deforms such that a part fitted between said inner peripheral face of said case and said end portion of said back electrode plate abuts against said spacer.
